(19) United States
(12) Patent Application Publication
(10) Pub. No.: US 2005/0250650 A1
(43) Pub. Date: Nov. 10, 2005

(54) Ice block delivery device containing active agent, and applicator therefor

(76) Inventors: Garth Meier, Grand Junction, CO (US); Craig B. Meier, Billings, MT (US)

Correspondence Address: JACQUELINE S LARSON, P O BOX 2426, SANTA CLARA, CA, 95055-2426, US

(21) Appl. No.: 10/826,055

(22) Filed: Apr. 16, 2004

Related U.S. Application Data
(60) Provisional application No. 60/496,222, filed on Aug. 19, 2003.

(51) Int. Cl. A01N 25/00

(52) U.S. Cl. 504/358; 424/405

(57) ABSTRACT

The present invention is directed to a novel delivery system for the storage and the slow or otherwise controlled release of active agents to a selected treatment or delivery site. More particularly, the invention is directed to an active agent delivery system comprising an ice block delivery device, which comprises one or more active agents frozen in ice, and, optionally, an applicator for holding and delivering the active agents to a treatment or delivery site.

The present application claims the benefit of Provisional U.S. patent applications Ser. No. 60/463,680, filed Apr. 17, 2003, and Ser. No. 60/496,222, filed Aug. 19, 2003; the entire disclosures of which are incorporated herein by reference.

### FIELD AND BACKGROUND OF THE INVENTION

It is advantageous to supply to plants the necessary nutrients, such as nitrogen, phosphorous and potassium, at a controlled rate commensurate with the utilization of the nutrients by the plant. A number of controlled-release fertilizer delivery systems have been developed. However, they often have disadvantages, such as run-off and contamination of streams, lakes and groundwater; sprays that contaminate the air; carrier systems that remain after the fertilizer has been dispensed; and the like. Similar problems arise with pesticide delivery systems, as well.

### SUMMARY OF THE INVENTION

The present invention is directed to an active agent delivery system for the storage and the slow or otherwise controlled release of active agents to a site of delivery.

More particularly, the active agent delivery system comprises, in a first embodiment, an ice block delivery device, such as block ice or ice cubes, with one or more active agents suspended in the ice. The ice block delivery device holds the active agents in frozen suspension for storage and/or application to a treatment site. These ice block delivery devices provide slow or otherwise controlled release of the active agents to a designated site of delivery, by exposing or releasing the active agents to the site as the ice melts.

The active agent delivery system comprises, in a second embodiment, an ice block delivery device, as described above, and an applicator for controlling the proper dispensing and distribution of the active agents to a delivery site, such as a plant or a tree. The applicator is designed to accept and hold the ice blocks of the invention and to provide delivery of the active agents from the ice blocks to the plants to be treated at a chosen desired location and in a controlled manner.

The present invention is further directed to methods for making the active agent-containing ice block delivery devices of the invention and to methods for delivering active agents to a treatment or delivery site using the active agent delivery system of the invention.

### BRIEF DESCRIPTION OF THE DRAWINGS

FIG. 1 is a side view of one embodiment of an in-ground applicator delivery device for storing and controllably delivering active agents from an ice “block” to a plant or other site of delivery.

FIG. 2 is a bottom view of the in-ground applicator device of FIG. 1.

FIG. 3 is a side view of another embodiment of an in-ground applicator delivery device for storing and controllably delivering active agents from an ice “block” to a plant or other site of delivery.

FIG. 4 is a view of another embodiment of an applicator delivery device for storing and controllably delivering active agents from an ice “block” to a plant or other site of delivery.

FIG. 5 is a side view of another embodiment of an applicator delivery device for storing and controllably delivering active agents from an ice “block” to a plant or other site of delivery.

### DETAILED DESCRIPTION OF THE INVENTION

The terms “a” and “an”, as used herein, mean “one or more” unless specifically indicated otherwise.

“Treatment site” and “delivery site” are used interchangeably herein, unless specifically indicated otherwise.

The term “block” is used herein and in the appended claims for convenience to describe the active agent-containing ice delivery device of the present invention. However, this invention is not limited to a block shape but can take any desired shape that is suitable for the intended use. Thus, the ice delivery device of the present invention may be of any convenient or desired size and any shape that can be formed by a mold into which water can be frozen into ice. Examples of such shapes include, but are not limited to, a sphere, a cone, a cube or a rectangle, or an article that is square, round, oval, or elliptical in cross-section, and the like. The ice block may be further manipulated to a different size or shape, such as by crushing, slivering, shaving, or the like, after it is frozen and prior to or at the time of application to the site. All such sizes and shapes are included herein under the term “block”.

The present invention is directed to a novel delivery system for the storage and the slow or otherwise controlled release of active agents to a selected treatment or delivery site. More particularly, the invention is directed to a delivery system comprising an ice block delivery device, which comprises one or more active agents frozen in ice, and, optionally, an applicator for holding and delivering the active agents. The applicator includes an outlet means, such as for example a hole or an opening porous to water and the active agent, for delivering the melted ice and active agents from the ice block to a site of delivery, which outlet means may, in one embodiment, be sized, have an adjustment means or a metering means, or be otherwise formed to allow the active agent-containing melted ice to be dispensed from the applicator into the delivery site at a predetermined controlled rate.

Active agents useful in the present invention may be liquids or water-soluble or non-soluble solids, granules or particles. Examples of active agents include, but are not limited to, fertilizers, pesticides, algaecides, therapeutic agents, bactericides, nematocides, nutrients, vitamins, minerals, supplements, alcohol, and the like. The percentage of active agent(s) within the ice block can be varied and will be dependent upon the particular active agent(s) used and/or the use contemplated. Such percentages are known in the art or can be determined without undue experimentation. It is presently preferred that the active agents be a homogeneous mixture within the ice block; however, this is not required.

Any suitable fertilizer source material may be used in the ice blocks of the invention. The amounts of available nitrogen, phosphorous and potash, or “NPK”, may be varied in accordance with the requirements of the plants to be fertilized. Conventional fertilizer percentages such as 16:8:8, 8:4:4, 5:5:5, 15:5:5 or 22:11:11, or the like may be provided by the ice block of the invention. Often, the greater the concentration of N:P:K, the smaller the size and/or number of ice blocks required. The fertilizer mixture may be purchased as an already-prepared formulation (such as, for example, those marketed by MIRACLE GRO®, BEST®, ORTHO®, SCOTT®, etc.), or it may be mixed as a custom blend immediately prior to or as it is placed into water and frozen to prepare the ice block. Various fertilizer source materials may be used; for example, ammonium sulfate, ammonium nitrate, mono-ammonium phosphate, urea, or other known sources of nitrogen may be used alone or in mixtures. Diammonium phosphate, triple super phosphate, normal super phosphate or mono-ammonium phosphate may be used to supply the phosphorous. Potassium chloride or potassium sulfate may be used as the source of potash. Trace elements and secondary nutrients such as calcium, magnesium and sulfur may be included in the mixture, if desired. The trace elements may include iron, copper, manganese, barium, zinc and molybdenum.

Pesticides useful as the active agent in the present invention include, but are not limited to, insecticides, insect repellents, acaricides, herbicides, fungicides, and the like. Such pesticides are well known in the art and may be selected from, but are not limited to, an herbicide such as atrazine, simazine, cyanazine, terbuthylazine, diuron, chlorsulphuron, metsulfuron, tralkoxydin, or 2-(2-chloro-4-mesylbenzoyl)cyclohexane-1,3-dione; an insecticide such as deltamethrin, lindane, carbaryl, endosulfan, permethrin, carbofuran, or insect growth regulators such as methoprene; a fungicide such as thiophanate methyl, carbendazim, flutriafol, hexaconazole, chlorothalonil, copper oxychloride, captan or thiram; or an acaricide such as hexythiazox, cyhexatin, amitraz or acrinathrin.

In one embodiment, the present invention is useful for dispensing insecticides to an environment to be treated against insects, such as termites, ants including fire ants, aphids, spider mites, flies, and other plant or animal (including human) pests. Such insecticides are known in the art. For example, the invention can be particularly useful for treating an aqueous environment for the control of aquatic insect populations, such as mosquitoes. Mosquito insecticides suitable for use in the present invention include, but are not limited to, those listed in the following Table A:

TABLE A
Pesticides used for mosquito control in the United States

| Name | Trade Name | Formulation^{a} | Application | Advantage | Limitation |
|---|---|---|---|---|---|
| Temephos | Abate | G, EC | Larvae | Usually lowest cost | Nontarget effects, |
| | | | | | some resistance |
| Methoprene | Altosid | G, B, P, LC | Larvae | Residual briquets, | Cannot be certain |
| | | | | nontarget safety | of performance |
| | | | | | until too late to |
| | | | | | retreat |
| Pyriproxyfen | Nylar | EC | | | |
| Oils | BVA, Golden Bear | Oil | Larvae, pupae | Acts on pupae | Oil film, |
| | | | | | subsurface larvae |
| Monomolecular | Agnique | Liquid | Larvae, pupae | Acts on pupae | Subsurface larvae |
| film | | | | | |
| Bacillus | Aquabac, | WDG, AS, P, U, B | Larvae | Nontarget safety, | Short window of |
| thuringiensis | Bactimos, LarvX, | | | Briquets control | treatment |
| israelensis (Bti) | Teknar, Dunks | | | 30+ days | opportunity, pupae |
| Bacillus sphaericus | VectoLex | G, WDG | Larvae | Nontarget safety | Pupae, only works |
| (Bs) | | | | | in fresh water |
| Malathion | Fyfanon, Atrapa, | ULV, thermal fog | Adults | Tolerances | OP^{a}, some |
| | Prentox | | | | resistance |
| Naled | Dibrom, Trumpet | ULV, EC, thermal | Adults | Tolerances | OP, corrosive |
| | | fog | | | |
| Fenthion | Batex | ULV | Adults | None specified | OP, Florida only, |
| | | | | | RUP^{a}, tolerances |
| Permethrin | Permanone, | ULV, thermal fog, | Adults, clothing | Low vertebrate | None specified |
| | AquaResilin, | clothing treatment | treatment for ticks | toxicity | |
| | Biomist, Mosquito- | | and mosquitoes | | |
| | Beater | | | | |
| Resmethrin | Scourge | ULV, thermal fog | Adults | Low vertebrate | RUP, no tolerance |
| | | | | toxicity | for residue on |
| | | | | | crops |
| Sumithrin | Anvil | ULV, thermal fog | Adults | Low vertebrate | No tolerance |
| | | | | toxicity | |
| Pyrethrins | Pyrenone, Pyronyl | ULV, EC | Adults, larvae | Natural pyrethrum, | May be costly |
| | | | | tolerances | |

^{a}AS = Aqueous suspension;
B = Briquets;
EC = Emulsifiable concentrate;
G = Granules;
LC = Liquid concentrate;
P = Pellets;
ULV = Ultra low volume;
WDG = Water-dispersible granule;
OP = Organophospate insecticide;
RUP = Restricted use product

Therapeutic agents which may be used in the invention include, but are not limited to, those that act on the cardiovascular system, smooth muscle cells, blood circulatory system, immunological system, and the like. The active drug that can be delivered for acting on these recipients includes, but is not limited to those that act as analgesics, immunomodulators, anti-inflammatories, calcium antagonists, antihypertensives, antipyretics, beta-blockers, antibiotics, chemotherapeutics, cardiovascular drugs, and the like. The therapeutic agents can be in various pharmaceutically acceptable forms, such as prodrugs, uncharged molecules, molecular complexes, and pharmacologically acceptable salts. Derivatives of medicines, such as esters, ethers and amides, can be used.

Different active agents may be combined (for example, as a simple mixture or as a chelate) into the ice blocks of the invention. For example, a fertilizer and an herbicide may both be present in an ice block, which, when placed at the base of the plant, provides not only nutrients for healthy growth of the plant but also minimizes or prevents growth and proliferation of weeds or other undesirable plants. As another example, a fertilizer and an insect repellent may be placed together in an ice block, which both delivers nutrients to the plant and repels undesirable insects from the areas around the plant. Alternatively, a fertilizer and a systemic insecticide may be applied together to a plant via an ice block, delivering both nutrients and insecticide to the plant through its roots. Additionally, other ingredients may optionally be added to the ice block, such as, but not limited to, dyes or other colorants, flavorings, and fragrances, for example.

The present invention is also directed to the process for making the active agent-containing ice blocks. The active agent(s) are dissolved or suspended in water and then frozen into a solid water ice block. This freezing into ice blocks may be by any means known in the art, including, but not limited to, the use of hydraulic compression of smaller ice cubes or pieces into a larger ice block or the use of automatic ice machines, such as the FREEZE SEAL® ice machine (Colorado Contracting Inc., Grand Junction, Colo.; U.S. Pat. No. 5,167,132, the entire disclosure of which is incorporated herein by reference). When using automatic ice machines, the active agent(s) are mixed in a holding tank in the desired ratios with water and any other optional ingredients. The mixture is then circulated from the tank to the ice block- or ice cube-producing equipment and frozen into blocks of ice. The active agent-containing ice blocks can then be stored at freezing temperature until they are used, at which time they are placed at the site of delivery.

In another embodiment, the ice blocks may be formed by placing water and active agent(s) into a container, which may conveniently include a removable closure, such as a top or cap. The water and active agent(s) may be immediately frozen and stored in the container or they may be stored in non-frozen form until just prior to application, at which time the filled container is placed into a freezer and the water/active agent(s) are frozen to form the ice block. The container may act simply as a mold, in which case the container is removed from the ice block prior to placement of the block at the site of delivery. Alternatively, the container may conveniently act as an applicator, in which case the container with enclosed ice block is placed at the delivery site. In this latter embodiment, the container/applicator will have an outlet for delivery of the melted ice and active agents from the container/applicator to the site. The outlet may take the form of an opening, with or without a top or cap, or it may be an extension, such as a tube or wicking material for example, for delivering melted ice/active agents from the container to a site of delivery.

The invention is further directed to methods of delivering active agents to a delivery site, the method comprising placing the active agent-containing ice block delivery device at the site and allowing the ice to melt, releasing the active agents to the site. Ice blocks according to one embodiment of the invention may contain fertilizers, which ice blocks can be placed at the base of plants to deliver the fertilizer to the plants as the ice melts. Alternatively, the fertilizer-containing ice blocks may be used in conjunction with an irrigation system, where the ice blocks are placed into a container at or near the source of water for the system, such that the water for the system is pumped over and around the blocks, resulting in the water eroding the blocks and carrying the exposed fertilizer along to be delivered to the plant along with the water. In another embodiment, the ice blocks of the invention may contain insecticides for placement in drainage ditches, ponds, and the like for controlling mosquitoes and other water-borne insect pests. In a further embodiment, ice blocks according to the invention may contain algaecides for algae control in ponds and pools and the like. In yet another embodiment of the invention, active agents for ingestion by humans and other animals, such as medications, vitamins, minerals, supplements, alcohol/liquor, and the like, are placed in the ice blocks, which are then used to administer the active agents (for example, as ice cubes in drinks for humans or as animal licks at zoos and farms). Ice blocks for ingestion may optionally include other ingredients such as flavorings, colorings, and the like to make the ice block more palatable. Similarly, ice blocks may be utilized for transdermal application of analgesics or the like to swollen, stressed, pulled or sore joints or muscles.

Other active agents and uses can be imagined by one of skill in the art, and all such active agents and uses are contemplated by and encompassed within the present invention.

In addition to storage and controlled delivery of active agents, when used with plants, trees, grass and the like the ice block delivery devices of the invention provide the added benefit of irrigating the plant as the ice melts.

When the ice blocks are used to deliver insecticide or algaecide to a body of water, because the carrier device is only water, once the ice has melted no carrier residue is left behind to pollute the body of water, in contrast to prior art insecticide blocks and briquets.

The present invention is further directed to applicators for controlling the proper dispensing and distribution of active agents to plants, trees and other environments. The applicator is designed to accept and hold the ice blocks of the invention and to provide delivery of the active agents from the ice blocks to the environment to be treated at a chosen desired location and in a controlled manner. This eliminates surface runoff of the active agent, which can contaminate surface water. It also eliminates the waste of water caused by evaporation or surface runoff.

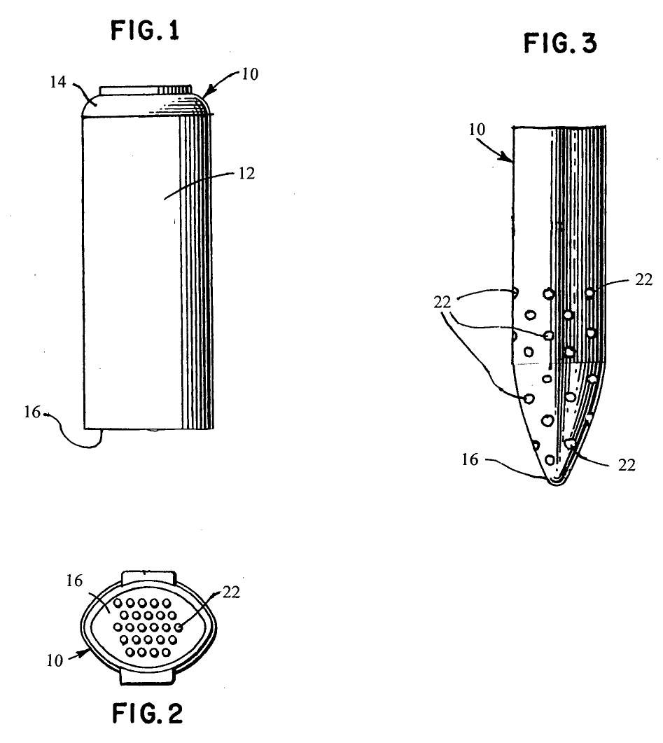

In one embodiment, the applicator is an in-ground applicator. Preferably, the in-ground applicator is placed into the ground at a location at or near the plants to be fed, preferably at about the drip line of the plants, and at a depth below the ground sufficient to treat the roots, preferably the deeper roots, of the plants. Referring to FIGS. 1, 2 and 3, the applicator (10) has a body or enclosure (12) that is of a shape suitable for receiving one or more active agent-containing ice blocks and of an appropriate length to reach the desired root depth. It may include a top or cap (14) or it may be open at the top. The top or cap may be closed by a snap lock, a screw top, or any other method known for affixing a cap to a container. The applicator has one or more outlet means or porous openings, preferably but not necessarily at or near its bottom (16), for passage of the melting ice and the active agents contained in the melting ice into the ground in proximity to the plant roots. The outlet means or porous opening(s) may be holes (22) of appropriate size in the walls, generally but not necessarily at or near the bottom surface, of the applicator; or the porous opening may be mesh, a screen, a permeable membrane, or any other means or system capable of allowing water and active agent to pass through and out of the applicator into the surrounding ground. The hole or porous openings may be sized, have an adjustment means or a metering means, or be otherwise formed to allow the melted ice and active agents to be dispensed in a controlled manner.

This method of application insures that all of the active agent is applied underground for complete uptake and use by the plant. Additionally, by controlling the irrigation and application of active agents below the surface level, the root growth is directed downward, thereby eliminating a horizontal surface growth pattern, which can be undesirable because it can cause uneven ground surfaces and sidewalk lifting.

A further benefit of using the in-ground applicator of the present invention to deliver the active agent-containing ice blocks is that the plants are deeply irrigated as the ice melts. Besides encouraging downward root growth, such deep irrigation eliminates the waste of water caused by evaporation or surface runoff. In a related embodiment, the applicator may be used with ice blocks that do not contain any active agent as an effective means of watering plants and trees during a drought or in dry or desert areas. Application below ground delivers the melting water directly to the roots where it is needed and prevents loss of water by runoff or evaporation.

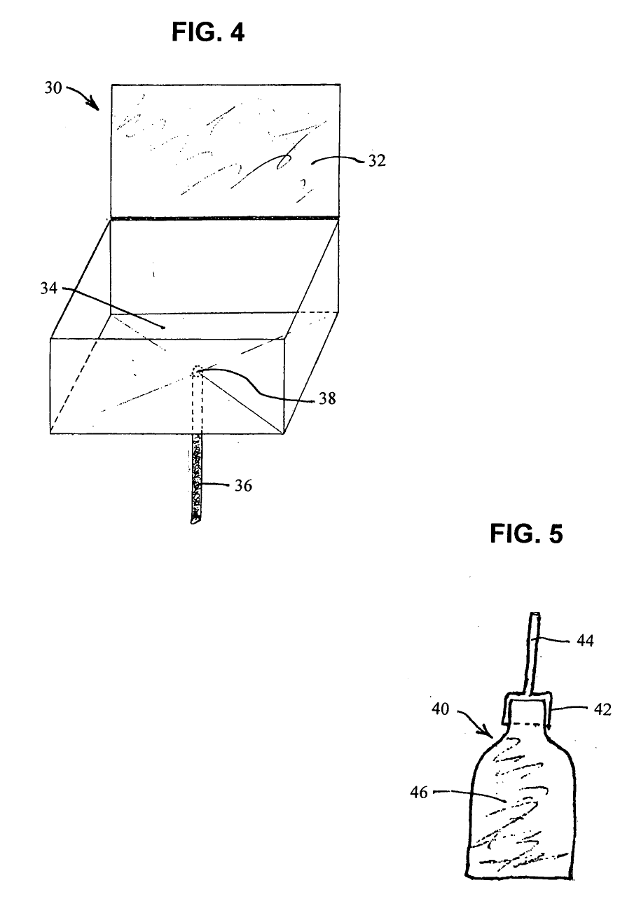

In another embodiment, the applicator of the invention may take the shape of a container that includes a section that is adapted to receive and hold the ice blocks of the invention. The container may be, but is not limited to, a bottle, a box, or a lawn or garden ornament (such as a statue or a fountain or a base or pedestal for holding an ornament or a sundial, for example). Referring to FIG. 4, the container (30) may have a lid or top (32) or other opening for providing access to an enclosure (34) for receiving and holding one or more ice blocks. The bottom of the container may have an extension (36) extending from an opening (38) in the bottom of the container and adapted to go into the ground, the extension being in effect an in-ground applicator as described hereinabove. Alternatively, the bottom of the container or ornament may itself have one or more porous openings (such as holes or a screen or mesh, for example) for passage of the melting ice and the active agents contained in the melting ice into the ground at the interface of the ground and the bottom of the container or ornament. The holes or porous openings may be sized, have an adjustment means or a metering means, or be otherwise formed to allow the liquid and active agents to be dispensed in a controlled manner. Instead of or in addition to an in-ground applicator or porous openings in its bottom, the container or ornament may have extensions from the container for delivering the melting ice and active agents to plants or trees. The extensions are preferably tubes, which may be drip irrigation tubes or soaker tubes for slow release of the agents to the plant or tree. Alternatively, the extensions can be formed of rope or string or other material that will wick the active agent-containing melted ice to the plant or tree.

In a further embodiment, the applicator may be in the shape of an edger box for placing at the edge of planting beds or around trees, the edging box being adapted to receive and hold the ice blocks of the invention. The bottom of the edging box may have one or more extensions that go down into the ground, the extension being in effect an in-ground applicator as described above. Alternatively, the bottom of the edging box may itself have one or more porous openings (such as holes or a screen or mesh, for example) for passage of the melting ice and the active agents contained in the ice into the ground at the interface of the ground and the bottom of the edging box. The holes or porous openings may be sized, have an adjustment means or a metering means, or be otherwise formed to allow the liquid and active agents to be dispensed in a controlled manner. Instead of or in addition to an in-ground applicator or porous openings in its bottom, the edging box may have extensions from the box for delivering the melting ice and active agents to the plants or trees in the planting bed. The extensions are preferably tubes, which may be drip irrigation tubes or soaker tubes for slow release of the agents to the plant or tree, ropes made of wicking material.

In another embodiment, FIG. 5, the applicator may be a bottle or other container (40) that defines an enclosure (46) for holding liquid or an ice block and has a lid or top (42) that is reversibly removable. The top includes an extension (44) that is adapted to go down into the ground, the extension being in effect an in-ground applicator as described above. The extension may have one hole at its distal end for allowing liquid or melting ice and active agents to pass out into the surrounding ground or it may have other porous openings, as described earlier herein with respect to an in-ground applicator. The hole or porous openings may be sized, have an adjustment means or a metering means, or be otherwise formed to allow the liquid and active agents to be dispensed in a controlled manner. Preferably, the top (42) is interchangeable with a normal lid, top or other enclosure that does not include the extension (44). The top (42) can be removed, water and active agent(s) placed into the bottle (40) and the normal top placed on to close the bottle. The bottle then acts as a storage container for the water and active agents, which may remain in unfrozen form in the bottle prior to application if desired, for ease of storage for example. When application is desired, the bottle may be placed into a freezer to freeze the water and active agents into the ice block of the invention. The normal top is then removed and replaced with top (42). Extension (44) is directed into the ground at a desired depth to deliver the melted ice and active agents to the surrounding ground.

Any suitable impact-resistant synthetic resin adapted to be shaped by injection molding, casting or other conventional plastic molding technique may be used for molding the applicator of the invention, such as, for example, polypropylene, polyethylene, polycarbonate or polyurethane. Alternatively, the applicator may be formed of other materials such as, for example, stone, concrete, glass, or a rust-resistant metal such as aluminum. Biodegradable materials, such as paper or other cellulosics, may also be used to form the applicator.

The applicator of the invention may, in another embodiment, be a plastic bag for storing, transporting and delivering the ice block delivery device to the site of application. The plastic bag may be completely non-porous and is cut or torn open to release the active agent-containing ice block. Alternatively, it may be porous to the active agent-containing melted ice in at least a portion of its surface. The porous portion may be one or more holes or screen, mesh or porous plastic material, and it is preferably covered by a non-porous material so that the ice will not evaporate during storage, which non-porous material is removed immediately prior to application to the delivery site. It may be desirable in certain circumstances, such as in high wind areas or the like for example, to provide a means for attaching or holding the ice block-containing bag at the point of delivery so that the porous portion of the bag remains at the delivery site. Thus, for example, a heavy object such as a brick or a rock may be placed on a portion of the bag, or a stake make be driven through the bag and into the ground to secure the bag to the site.

Although the invention has been described in detail for the purposes of illustration, it is to be understood that such detail is solely for that purpose and that variations can be made therein by those skilled in the art without departing from the spirit and scope of the invention.

### EXAMPLES

### Example 1

A fertilizer-containing ice block measuring 4×6×11 inches (1.25 gal. water) was manufactured by suspending a commercial over-the-counter 20-20-20 N-P-K fertilizer in water, which was then pumped into a FREEZE SEAL® ice machine and frozen. The resulting fertilizer-containing ice block was placed into an aluminum box, as illustrated by FIG. 4, the box being placed at the drip line of a honey locust tree. The ice block took approximately 4 days to completely melt away. Another honey locust tree of the same size and age as and planted within 20 feet of the ice block-treated tree was treated with conventional slow-release tree fertilizer spikes (Jobe's® Fertilizer Spikes) according to the package directions. The ice block-treated tree received a fertilizer-containing ice block approximately every two months. After one year, while the two trees were about the same height, the ice-block treated tree was noticeably heftier; that is, its trunk was about 1 inch larger in circumference and it had more and denser branches.

### Example 2

Fertilizer-containing ice cubes were prepared by mixing 20-20-20 N-P-K fertilizer into water, which was pumped into a commercial ice-cube machine. The cubes were frozen and bagged in water-impermeable plastic bags. The bags were stored in a freezer until use, at which time a bag was opened and the ice cubes were easily administered by sprinkling the cubes out of the bag onto flowers in a flower bed. Because of their weight, the ice cubes fell directly onto the ground (rather than sticking to the flowers and leaves of the plants), where they melted to release the fertilizer to the flowers. The ice block-fertilized flower plants were larger and healthier and had more blooms than flower plants that were untreated.

### Example 3

Ice cubes containing commercial grass fertilizer for use on golf courses were prepared and packaged according to the procedure of Example 2. The fertilizer-containing ice cubes were distributed onto a golf course, where they melted within 30 minutes to release the fertilizer into the ground. In contrast, the normal fertilizer applied to golf courses is a granular material, which remains on the grass for a substantial period of time, causing interference with golfers' games, such as by flying into the air when balls are hit and slowing the balls as they roll on the ground.

### Example 4

A fertilizer-containing ice block was prepared following the procedure of Example 1, except that a commercially available 8-0-8 NPK fertilizer was used. The ice block was placed in a water-impermeable plastic bag. At the treatment site, the bag was torn open on one side to expose the ice block, and the ice block was placed in contact with the sandy soil around the base of a queen palm tree and allowed to melt. The plastic bag remained covering most of the ice block to prevent loss of water by evaporation into the air and to more effectively irrigate the palm tree while at the same time fertilizing it. The plastic bag and the ice block were held in place in this windy location by a metal spike that was driven through the bag and into the ground. The treated palm trees exhibited top fronds that were less yellow than untreated palm trees.

### Example 5

Margaritas were prepared as follows: Margarita mix and tequila were mixed together and a margarita-containing ice block was prepared according to the procedure of Example 1. The margarita ice block was placed in a plastic bag for storage until use. It is conveniently shaped to be placed in a cooler for transporting to a camping or picnic site or for carrying on a river raft, for example. The margarita ice block was then broken into smaller pieces, by shaving or hammering or the like, and the pieces of margarita ice were placed into glasses for consumption.

1. An active agent delivery system for storing and controllably releasing active agents to a site of delivery, which comprises an ice block delivery device comprising one or more active agents frozen in ice.

2. An active agent delivery system according to claim 1 wherein the active agents are selected from the group consisting of fertilizers, pesticides, algaecides, therapeutic agents, bactericides, nematocides, nutrients, vitamins, minerals, supplements, and alcohol.

3. An active agent delivery system according to claim 1 wherein the active agents are pesticides.

4. An active agent delivery system according to claim 1 wherein the active agents are fertilizers.

5. An active agent delivery system according to claim 1 wherein the ice block delivery device is in the form of a block of ice.

6. An active agent delivery system according to claim 1 wherein the ice block delivery device is in the form of ice cubes.

7. An active agent delivery system according to claim 1 which further comprises an applicator, the applicator comprising an enclosure for holding the ice block delivery device and an outlet means for controllably delivering melted ice and active agents to the site of delivery.

8. An active agent delivery system according to claim 7 wherein the outlet means is selected from the group consisting of one or more holes, a screen, mesh, a permeable membrane, and an in-ground applicator.

9. An active agent delivery system according to claim 7 wherein the applicator is an in-ground applicator.

10. A method for controllably releasing active agents to a delivery site, which comprises placing an ice block delivery device at the delivery site, the ice block delivery device comprising one or more active agents frozen in ice.

11. A method according to claim 10 wherein the active agents are selected from the group consisting of fertilizers, pesticides, algaecides, therapeutic agents, bactericides, nematocides, nutrients, vitamins, minerals, supplements, and alcohol.

12. A method according to claim 10 wherein the active agents are pesticides.

13. A method according to claim 10 wherein the active agents are fertilizers.

14. A method according to claim 10 wherein the ice block delivery device is in the form of an ice block.

15. A method according to claim 10 wherein the ice block delivery device is in the form of ice cubes.

16. A method according to claim 10 which further comprises an applicator, the applicator comprising an enclosure for holding the ice block delivery device and an outlet means for delivering melted ice and active agents to the site of delivery.

17. A method according to claim 16 wherein the outlet means is selected from the group consisting of one or more holes, a screen, mesh, a permeable membrane, and an in-ground applicator.

18. A method according to claim 16 wherein the applicator is an in-ground applicator.

19. An applicator for controllably releasing active agents to a delivery site, which comprises i) an enclosure for holding an ice block delivery device comprising one or more active agents frozen in ice, and ii) an outlet means for delivering melted ice and active agents to the site of delivery.
